(19) United States
(12) Patent Application Publication
(10) Pub. No.: US 2025/0272034 A1
(43) Pub. Date: Aug. 28, 2025

(54) IMAGE FORMING APPARATUS, METHOD OF IMAGE FORMING APPARATUS, AND STORAGE MEDIUM

(71) Applicant: CANON KABUSHIKI KAISHA, Tokyo (JP)

(72) Inventor: HIROYA IGARASHI, Ibaraki (JP)

(21) Appl. No.: 19/057,770

(22) Filed: Feb. 19, 2025

(30) Foreign Application Priority Data
Feb. 27, 2024 (JP) 2024-027115

(51) Int. Cl. G06F 3/12

(52) U.S. Cl. CPC G06F 3/1239; G06F 3/1204

(57) ABSTRACT

An image forming apparatus including a plurality of sheet feeding sections prints an image on a sheet and restricts, based on receiving an instruction from a user, printing using at least one of the plurality of sheet feeding sections, wherein, in a case where same information as information indicating a type of a sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted.

### BACKGROUND

### Field

The present disclosure relates to an image forming apparatus, a method of an image forming apparatus, and a storage medium.

### Description of the Related Art

There is a technique for specifying in advance a sheet feeding stage to be used and switching the permission and the prohibition of the use of the sheet feeding stage to prevent a special print sheet from being used for normal printing (Japanese Patent Application Laid-Open No. H8-248709).

Japanese Patent Application Laid-Open No. H8-248709 discusses restricting printing using a sheet feeding stage specified by a user.

The restriction of the use of the sheet feeding stage requires an instruction from the user. For example, when a sheet of the same type as the type of a sheet already set in a sheet feeding stage restricted from being used for printing is also newly set in another sheet feeding stage, the user needs to provide an instruction to restrict printing using another sheet feeding stage, which is troublesome.

### SUMMARY OF THE INVENTION

The present disclosure is directed to reducing the trouble of a user when printing using a particular sheet feeding stage is restricted.

According to an aspect of the present disclosure, an image forming apparatus includes a plurality of sheet feeding sections, at least one memory storing instructions, and at least one processor that, upon execution of the stored instructions, causes the at least one processor to print an image on a sheet, and restrict, based on receiving an instruction from a user, printing using at least one of the plurality of sheet feeding sections, wherein, in a case where same information as information indicating a type of a sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted.

Further features of the present disclosure will become apparent from the following description of exemplary embodiments with reference to the attached drawings.

### BRIEF DESCRIPTION OF THE DRAWINGS

FIG. 1 is a system configuration diagram according to a first exemplary embodiment.

FIGS. 2A and 2B are a hardware block diagram and a software configuration diagram of an image forming apparatus according to the first exemplary embodiment.

FIGS. 3A and 3B are a hardware block diagram and a software configuration diagram of a print control apparatus according to the first exemplary embodiment.

FIG. 4 is a flowchart illustrating a content of a sheet feeding determination process in a printing process according to the first exemplary embodiment.

FIG. 5 is a diagram illustrating an example of setting information regarding sheet feeding stages according to the first exemplary embodiment.

FIG. 6 is a diagram illustrating an example of an out-of-sheets error screen of the image forming apparatus according to the first exemplary embodiment.

FIG. 7 is a diagram illustrating a sheet feeding stage reservation setting screen of the image forming apparatus according to the first exemplary embodiment.

FIG. 8 is a diagram illustrating a top screen of a sheet management application according to the first exemplary embodiment.

FIG. 9 is a flowchart when the sheet management application reserves sheet feeding stages according to the first exemplary embodiment.

FIG. 10 is a diagram illustrating a sheet information list of sheet information that can be set for the image forming apparatus according to the first exemplary embodiment.

FIG. 11 is a flowchart when a sheet management application reserves sheet feeding stages according to a second exemplary embodiment.

FIG. 12 is a diagram illustrating a sheet information list of sheet information that can be set for an image forming apparatus according to the second exemplary embodiment.

FIG. 13 is a diagram illustrating a sheet feeding stage reservation setting screen according to a third exemplary embodiment.

FIG. 14 is a flowchart when a sheet management application reserves sheet feeding stages according to a fourth exemplary embodiment.

FIG. 15 is a diagram illustrating a confirmation dialog when a sheet feeding stage reservation setting is made according to the fourth exemplary embodiment.

FIG. 16 is a flowchart when a sheet management application reserves sheet feeding stages according to a fifth exemplary embodiment.

FIG. 17 is a diagram illustrating a confirmation dialog when sheet feeding stage reservation settings are made according to the fifth exemplary embodiment.

FIG. 18 is a flowchart when a sheet management application reserves sheet feeding stages according to a sixth exemplary embodiment.

### DESCRIPTION OF THE EMBODIMENTS

In the present exemplary embodiments, a multifunction peripheral (MFP) having a print function is used as an example. An image forming apparatus according to the present disclosure is not limited to an MFP, and may be a single-function printer such as a single-function peripheral (SFP).

### <System Configuration>

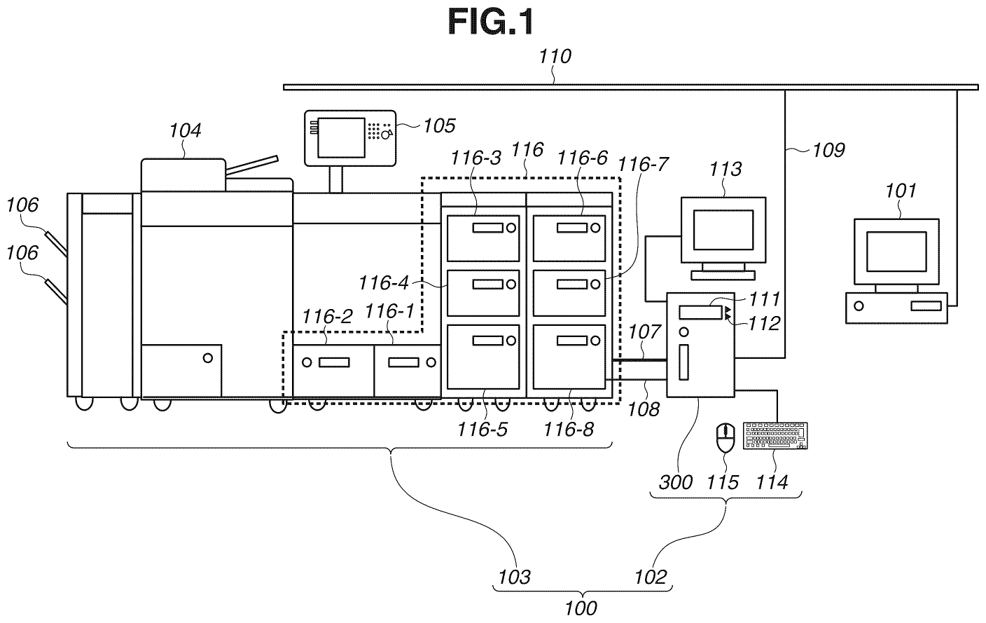

FIG. 1 is a block diagram illustrating the overall configuration of a printing system 100 according to a first exemplary embodiment.

The printing system 100 includes an image forming apparatus 103 and a print control apparatus 102. The printing system 100 is connected to a client computer 101. The client computer 101 and the print control apparatus 102 are connected via a local area network (LAN) 110 using an Ethernet cable 109. The print control apparatus 102 and the image forming apparatus 103 are connected via an image video cable 107 and a control cable 108. In the present exemplary embodiment, the image forming apparatus 103 is not directly connected to the LAN 110. The image forming apparatus 103 and the client computer 101 communicate with each other via the print control apparatus 102. Alternatively, the image forming apparatus 103 may be connected to the LAN 110. More specifically, the image forming apparatus 103 may be directly connected to the client computer 101. The client computer 101 starts an application and provides a print instruction to the printing system 100. The print control apparatus 102 cooperates with the image forming apparatus 103 to perform image processing.

The image forming apparatus 103 is a multifunction peripheral having various functions. The image forming apparatus 103 performs image processing according to an instruction from the client computer 101 or the print control apparatus 102, as well as copying data read from a scanner section 104 or transmitting the data to a shared folder. When the scanner section 104 scans an image, an operation panel 105 receives various instructions from a user via various keys. The operation panel 105 displays various information, such as a scanning state, via a panel. A sheet discharge section 106 receives a sheet on which an image is formed, and discharges the received sheet.

The print control apparatus 102 includes a controller 300 of the print control apparatus 102 and a display section 111. The display section 111 displays information in the print control apparatus 102. The user operates a hardware operation button section 112 of the print control apparatus 102, thereby performing an operation regarding the information displayed on the display section 111. The information displayed on the display section 111 is used to display the minimum required information (the operation of a power supply or the confirmation of an Internet Protocol (IP) address) for operating the print control apparatus 102. The controller 300 is connected to an external display device 113, a keyboard 114, and a pointing device 115 of the print control apparatus 102. In the first exemplary embodiment, the printing system 100 is described on the assumption that the print control apparatus 102 and the image forming apparatus 103 are different systems. In another exemplary embodiment, the processing of the print control apparatus 102 may be included in the image forming apparatus 103. In yet another exemplary embodiment, a configuration may be employed in which the external display device 113 has a position input device function as in a touchpad and functions also as the pointing device 115.

A plurality of sheet feeding stages 116-1 to 116-8 (collectively referred to as the “sheet feeding stages 116”) connected to the image forming apparatus 103 is devices that store sheets to be used for printing. If the image forming apparatus 103 receives a print instruction, a single sheet feeding stage is selected, and a sheet is fed from the selected sheet feeding stage. The number of sheet feeding stages 116 increases or decreases depending on the optional components connected to the image forming apparatus 103.

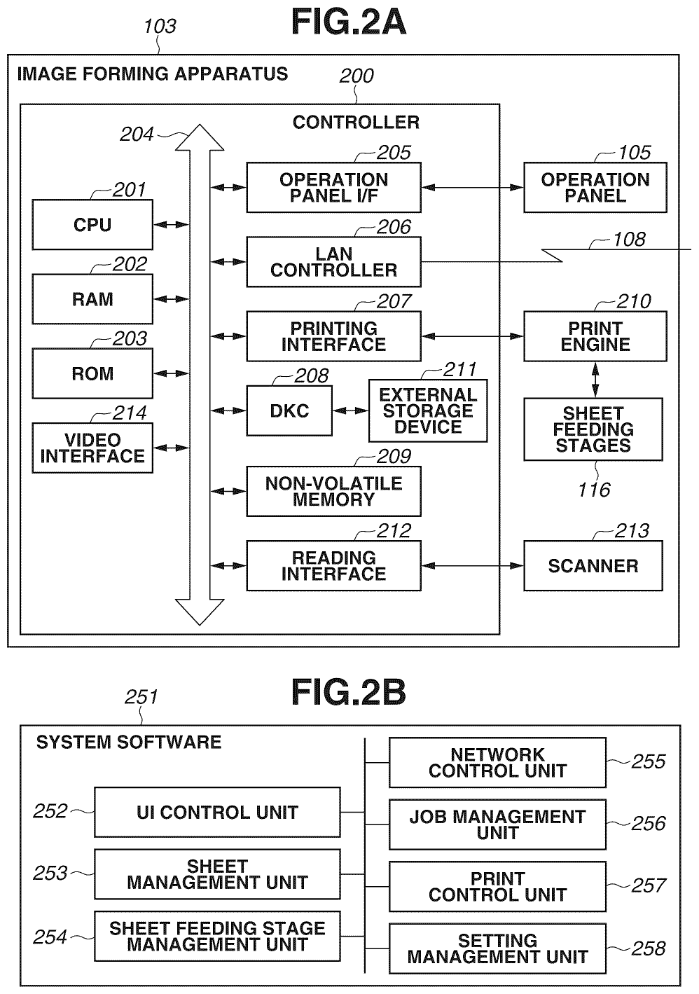

FIG. 2A is a block diagram illustrating the hardware configuration of the image forming apparatus 103.

A controller 200 includes a central processing unit (CPU) 201. The CPU 201 loads control programs stored in a read-only memory (ROM) 203 or an external storage device 211 into a random-access memory (RAM) 202 and executes the loaded programs, thereby performing control of various devices connected to a system bus 204. The CPU 201 also outputs an image signal as output information to a printing section (print engine) 210 connected to the CPU 201 via a printing interface 207 or receives an image signal input from a scanner 213 connected to the CPU 201 via a reading interface 212. The CPU 201 also controls the sheet feeding stages 116 connected to the print engine 210 or acquires the states of the sheet feeding stages 116 via the printing interface 207. The CPU 201 can perform a communication process with the print control apparatus 102 via a LAN controller 206 and the control cable 108. The RAM 202 functions as a main memory or a work area for the CPU 201. Access to the external storage device 211, such as a hard disk drive (HDD) or an integrated circuit (IC) card, is controlled by a disk controller (DKC) 208. The external storage device 211 stores an application program, font data, and form data, and is also used as a job storage area for temporarily spooling a print job and externally controlling the spooled job. The external storage device 211 is also used as a box data storage area that stores image data input from the scanner section 104 or image data of a print job as box data and prints the image data. In the first exemplary embodiment, an HDD is used as the external storage device 211, and stores various logs such as a job log and an image log. The operation panel 105 is connected to the controller 200 via an operation panel interface 205, and the user can input various information to the operation panel 105 using a software key or a hardware key. A non-volatile memory 209 stores various setting information set from a terminal via the operation panel 105 or the network (LAN) 110. A video interface 214 receives image data from the print control apparatus 102.

FIG. 2B is a block diagram illustrating the software configuration of the image forming apparatus 103.

The functions of components illustrated in FIG. 2B are achieved by the CPU 201 executing programs loaded into the RAM 202.

System software 251 controls the image forming apparatus 103, and includes a user interface (UI) control unit 252, a sheet management unit 253, a sheet feeding stage management unit 254, a network control unit 255, a job management unit 256, a print control unit 257, and a setting management unit 258.

The UI control unit 252 controls a screen displayed in the printing system 100. According to the settings of the system, the UI control unit 252 can perform control to switch the display of wording or the display unit system of a sheet size displayed on the operation panel 105. The sheet management unit 253 manages sheet information in a table format. The elements of the table are a sheet identifier (ID), the name of a sheet, a grammage, the size of a sheet, a width, a height, a color, a surface property, and a feature. The sheet feeding stage management unit 254 is involved in the settings of sheet information regarding the sheet feeding stage 116 via the printing interface 207 and the print engine 210.

The network control unit 255 controls communication between the image forming apparatus 103 via a LAN controller 306 and the print control apparatus 102 on the control cable 108 via the LAN controller 206. The job management unit 256 manages a printing process sequence and the order of jobs. The job management unit 256 manages a job received from the print control apparatus 102 or controls a print job received via the LAN controller 206 or the video interface 214. To print a print job received by the job management unit 256 on a sheet set in any of the sheet feeding stages 116, the print control unit 257 controls the print engine 210. The setting management unit 258 manages system settings regarding a sheet management system. The system settings include, for example, the language setting of wording or the display unit system (e.g., millimeters or inches) setting of a sheet size displayed on a screen of the sheet management system.

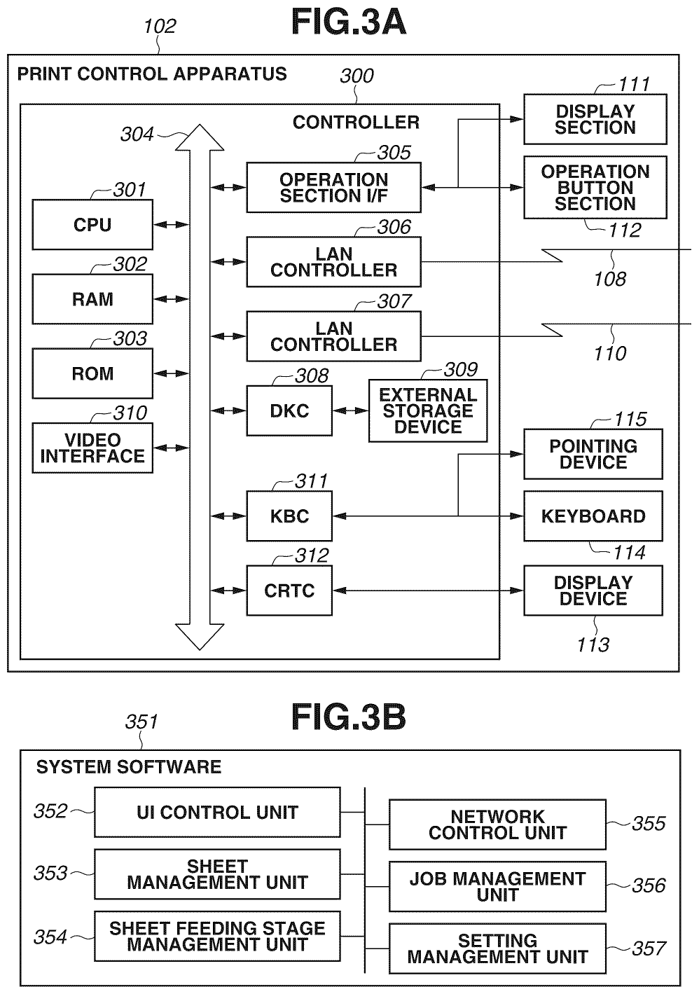

FIG. 3A is a block diagram illustrating the hardware configuration of the print control apparatus 102 according to the first exemplary embodiment.

The controller 300 includes a CPU 301. The CPU 301 loads control programs stored in a ROM 303 or an external storage device 309 into a RAM 302 and executes the loaded programs, thereby controlling various devices connected to a system bus 304. The CPU 301 can also communicate with the image forming apparatus 103 via the LAN controller 306 and the control cable 108. The CPU 301 can also perform a communication process with the client computer 101 or the image forming apparatus 103 on a network via a LAN controller 307 and the LAN 110. The RAM 302 functions as a main memory or a work area for the CPU 301. Access to the external storage device 309, such as an HDD or an IC card, is controlled by a disk controller (DKC) 308. The external storage device 309 stores an application program, font data, and form data or temporarily spools a print job. The external storage device 309 is used as a job storage area for performing a raster image processor (RIP) process on the spooled job and saving the spooled job again. An operation section interface 305 controls interfaces between the operation button section 112 via which the user inputs various information and the display section 111 that presents information to the user, and the controller 300. A video interface 310 transmits image data obtained by a RIP process to the image forming apparatus 103. A keyboard controller (KBC) 311 performs processing regarding the input of information from the keyboard 114 or the pointing device 115. A display control section 312 includes a video memory. Based on an instruction from the CPU 301, the display control section 312 draws image data in the video memory and also outputs the drawn image data drawn as a video signal to the display device 113.

FIG. 3B is a block diagram illustrating the software configuration of the print control apparatus 102 according to the first exemplary embodiment. The functions of components illustrated in FIG. 3B are achieved by the CPU 301 executing programs loaded into the RAM 302.

System software 351 controls the print control apparatus 102 and includes a UI control unit 352, a sheet management unit 353, a sheet feeding stage management unit 354, a network control unit 355, a job management unit 356, and a setting management unit 357. The UI control unit 352 controls a screen displayed in the printing system 100. According to the settings of the system, the UI control unit 352 can perform control to switch the display of wording or the display unit system of a sheet size displayed on a screen. The sheet management unit 353 communicates with the image forming apparatus 103 and manages acquired sheet information in a table format. The elements of the table are a sheet ID, the name of a sheet, a grammage, the size of a sheet, a width, a height, a color, a surface property, and a feature.

The network control unit 355 controls communication between the image forming apparatus 103 via the LAN controller 306 and the client computer 101 on the network 110 via the LAN controller 307. The job management unit 356 manages a printing process sequence and the order of jobs. The job management unit 356 manages a job received by the print control apparatus 102 and controls the transfer of data for printing the received job to the image forming apparatus 103 via the LAN controller 306 or the video interface 310. The setting management unit 357 manages system settings regarding a sheet management system. The system settings, for example, include the language setting of wording or the display unit system (e.g., millimeters or inches) setting of a sheet size displayed on a screen of the sheet management system.

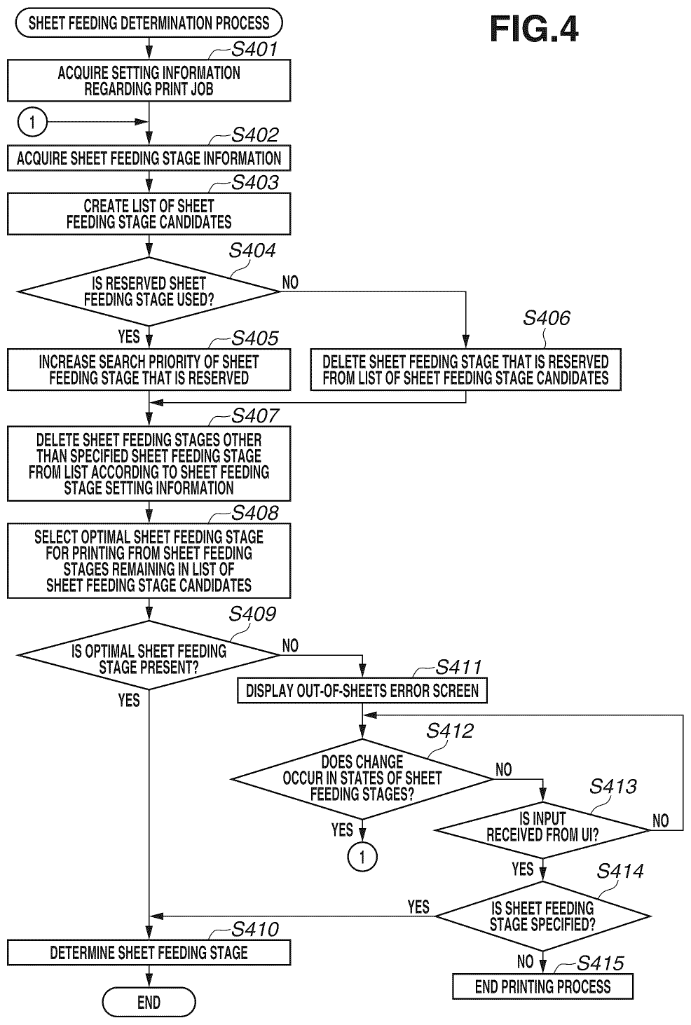

A flowchart illustrating an example of a sheet feeding determination process of the image forming apparatus 103 in FIG. 4 will now be described.

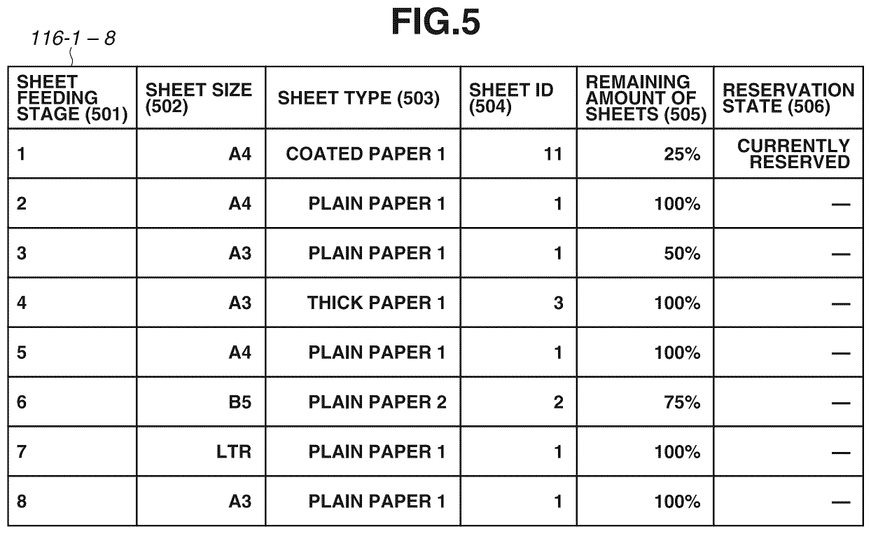

First, in step S401, the CPU 201 acquires setting information regarding a print job stored in the external storage device 211. The setting information regarding the print job includes a sheet size and a sheet type required for printing, sheet feeding stage setting information, and setting information indicating that a reserved sheet feeding stage is used. This setting information is included in the print job in a case where the user makes a setting for using a reserved sheet feeding stage when setting the print job. The setting information is not included in the print job in a case where the user does not make a setting for using a reserved sheet feeding stage when setting the print job. Next, in step S402, the CPU 201 acquires sheet feeding stage information stored in the external storage device 211. The sheet feeding stage information is setting information set with respect to each sheet feeding stage illustrated in FIG. 5. In step S403, the CPU 201 creates a list of sheet feeding stage candidates by duplicating the acquired sheet feeding stage information. The list of sheet feeding stage candidates is used to identify a sheet feeding stage as a sheet feeding candidate in subsequent processing.

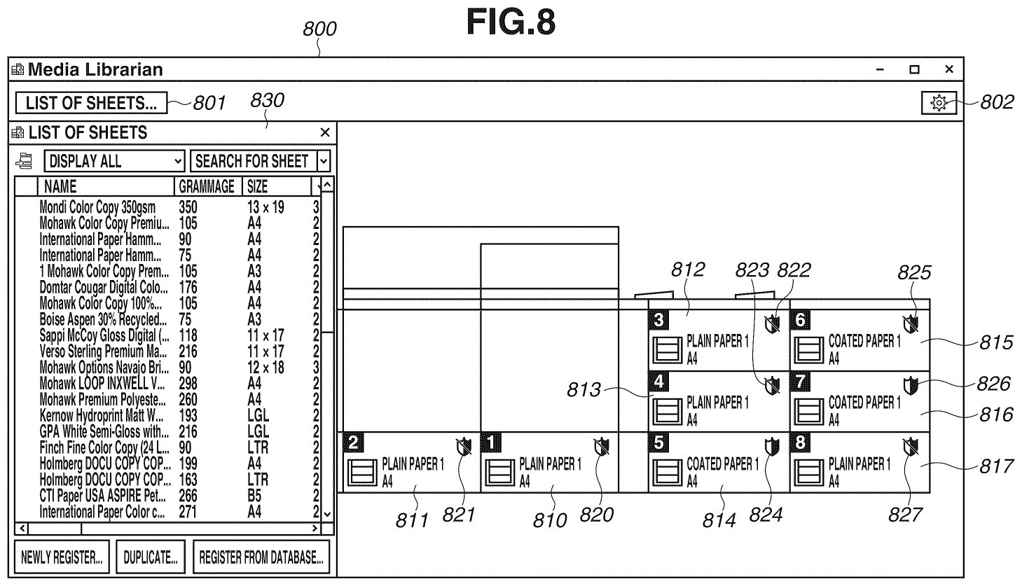

In step S404, based on the content of the setting regarding the use of a reserved sheet feeding stage in the print job acquired in step S401, the CPU 201 switches the next operation. A setting screen for a reserved sheet feeding stage will be described below with reference to FIG. 8. If the print job includes information indicating that a reserved sheet feeding stage is “used” (YES in step S404), the processing proceeds to step S405. In step S405, the CPU 201 rearranges the list of sheet feeding stage candidates created in step S403 so that a sheet feeding stage where a reservation state 506 is “currently reserved” is at the beginning of the list. In the selection of an optimal sheet feeding stage in step S408, the sheet feeding stage currently reserved can be preferentially selected. In the process of step S405, the priority order does not need to be rearranged, and a sheet feeding stage of which the reservation state 506 is not “currently reserved” may be eliminated from the candidates.

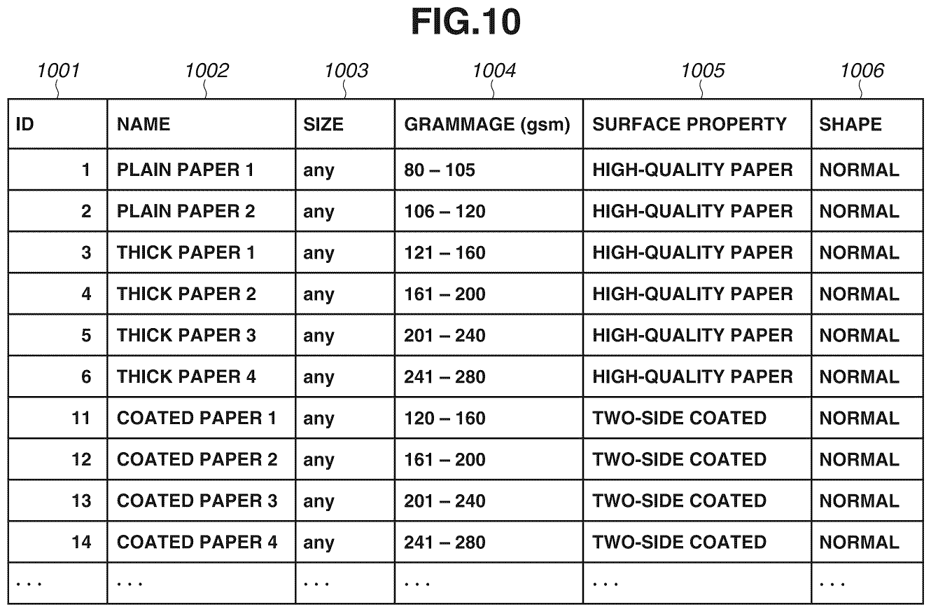

The setting information regarding sheet feeding stages illustrated in FIG. 5 is described. The setting information regarding the sheet feeding stages includes a sheet size (502), a sheet type (503), a sheet ID (504), the remaining amount of sheets (505), and a reservation state (506) set with respect to each sheet feeding stage (501), and information regarding sheets set for the sheet feeding stages is managed. This information is stored in the non-volatile memory 209 and is read and written by the CPU 301 where necessary. Specifically, this information is used in a case where information regarding the sheet feeding stages is displayed on the operation panel 105 or the settings of the sheet feeding stages are changed. The information regarding the sheet feeding stages is set using a sheet information list illustrated in FIG. 10. The sheet information list is stored in advance in the ROM 203 of the image forming apparatus 103 and is read and used by the CPU 201. The sheet information list includes a sheet ID 1001, a name 1002, a size 1003, a grammage 1004, a surface property 1005, and a shape 1006. These are merely examples, and the sheet information list may include another parameter indicating an attribute of a sheet. The sheet information list is used in a case where the information regarding the sheet feeding stages is changed on the operation panel 105 or the sheet feeding stage information is changed using a sheet management application. If the CPU 201 receives an instruction to change the sheet feeding stage information provided by a user operation, the CPU 201 writes sheet information specified from the sheet information list into the setting information regarding the sheet feeding stages. Specifically, the sheet ID 1001 is written into the sheet ID 504, the name 1002 is written into the sheet type 503. If the size 1003 is “any”, the sheet size 502 is a size specified by the user or a size automatically detected by the sheet feeding stage. The remaining amount of sheets 505 represents the remaining amount detected by each sheet feeding stage at five levels. The reservation state 506 will be described below. While not all of the sheet information list is written into the setting information regarding the sheet feeding stages, since the sheet ID 504 and the sheet ID 1001 are associated with each other on a one-to-one basis, the sheet information list can be referred to where necessary. The sheet information list may be in a format in which the user can add or delete sheet information using, for example, the non-volatile memory 209.

If, a setting is made in the job so that a reserved sheet feeding stage is “not used” (NO in step S404), the processing proceeds to step S406. In step S406, a sheet feeding stage that the reservation state 506 is “currently reserved” from among the sheet feeding stages in the list of sheet feeding stage candidates is deleted. In other words, printing using a sheet feeding stage that is reserved (restricted from being used) is prevented. For example, in a case where the reservation statuses of the sheet feeding stages are as illustrated in FIG. 5, and if a setting is made in the print job so that a reserved sheet feeding stage is not used, a sheet feeding stage 1, i.e., the sheet feeding stage 116-1, is deleted from the list of sheet feeding stage candidates. If a setting is made in the print job so that a reserved sheet feeding stage is used, no sheet feeding stage is deleted from the list of sheet feeding stage candidates. Thus, a sheet can be fed from a sheet feeding stage of which the reservation state 506 is “currently reserved” only in a job in which a setting is made so that a reserved sheet feeding stage is “used”. In other words, a sheet feeding stage restricted from being used for printing can be used for printing based on a print job including information indicating that a sheet feeding stage restricted from being used is used, and cannot be used for printing based on a print job that does not include the information indicating that a sheet feeding stage restricted from being used is used.

While in the present exemplary embodiment a description is provided using an example where the determination of whether to perform printing using a sheet feeding stage that is reserved (a sheet feeding stage restricted from being used for printing) is made based on the presence or absence of information included in a print job and indicating that a reserved sheet feeding stage is “used”, the present disclosure is not limited to this. For example, the determination may be made based on whether a print instruction is provided by the same user as a user who has reserved (restricted) the sheet feeding stage. In this case, the CPU 201 stores identification information regarding the user who has reserved the sheet feeding stage in the external storage device 211, and determines whether identification information regarding a user included in the received print job and the stored identification information match each other. If the identification information regarding the user included in the received print job and the stored identification information match each other, printing using the sheet feeding stage that is reserved is permitted. If the identification information regarding the user included in the received print job and the stored identification information do not match each other, printing using the sheet feeding stage that is reserved is prohibited. As an example of the prohibition, as illustrated in the process of step S406, the sheet feeding stage that is reserved is eliminated from candidates for automatic sheet feeding stage selection. If information that specifies the sheet feeding stage to be used (the sheet feeding stage that is reserved) is included in the print job, the execution of the print job is cancelled. A sheet feeding stage restricted from being used for printing can be used for printing based on a print instruction from a particular user who has reserved the sheet feeding stage, and cannot be used for printing based on a print instruction from a user different from the particular user.

An example of the prohibition in a case where a user different from a user who has reserved a sheet feeding stage is logged in to the image forming apparatus 103 is as follows. On a print setting screen for a copy function that is a screen for selecting a sheet feeding stage to be used for printing, a button for selecting a sheet feeding stage reserved by another user different from a user currently logged in may be grayed out. Alternatively, this button may not be grayed out, but may still not receive a setting even if the button is selected. A screen displayed when a user different from a particular user who has reserved a sheet feeding stage is logged into the image forming apparatus 103 and for selecting a sheet feeding stage to be used for printing is displayed such that a sheet feeding stage restricted from being used for printing cannot be selected.

Next, in step S407, the CPU 201 refers to the sheet feeding stage setting information in the setting information regarding the print job acquired in step S401 and deletes sheet feeding stages other than a specified sheet feeding stage from the list of sheet feeding stage candidates. The sheet feeding stage setting information is specified sheet feeding stage information. If a particular sheet feeding stage is specified in the sheet feeding stage setting information, sheet feeding stages other than the specified sheet feeding stage are deleted from the list of sheet feeding stage candidates. If automatic selection is set, none of the sheet feeding stages are deleted from the list of sheet feeding stage candidates.

Next, in step S408, the CPU 201 selects an optimal sheet feeding stage from the sheet feeding stages remaining in the list of sheet feeding stage candidates. Specifically, the CPU 201 searches for a sheet feeding stage that holds a sheet that matches the sheet size and the sheet type required for printing described in the setting information regarding the print job in order from a sheet feeding stage at the beginning of the list of sheet feeding stage candidates. In step S409, based on the result of searching for a sheet feeding stage, the CPU 201 switches the next process. If a sheet feeding stage is found (YES in step S409), then in step S410, a subsequent step in the flow is notified of the sheet feeding stage, and the sheet feeding determination process ends. A sheet feeding stage that is found first is set as a sheet feeding stage to be used in the job.

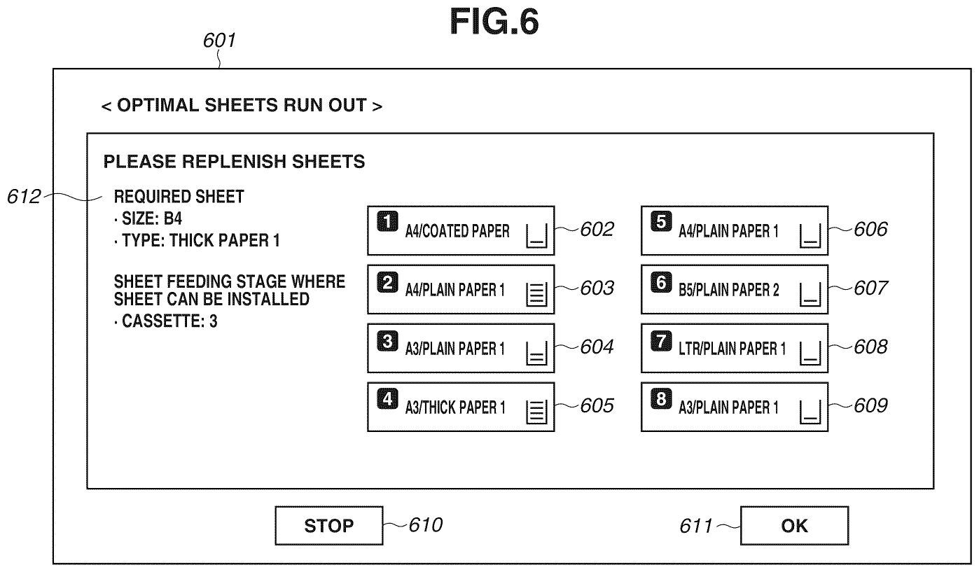

If it is determined in step S409 that a sheet feeding stage is not found (NO in step S409), then in step S411, the CPU 201 displays an out-of-sheets error screen 601 illustrated in FIG. 6 on the operation panel 105 via the operation panel interface 205. The out-of-sheets error screen 601 displays a message 612 indicating information regarding (the size and the type of) a sheet required to continue the print job, and a sheet feeding stage where the sheet can be installed. The CPU 201 searches for the sheet feeding stage where the sheet can be installed in the list of sheet feeding stage candidates after the process of step S407.

The error screen 601 displayed in step S411 may always be the same screen if an optimal sheet feeding stage is not present, or may be switched depending on the condition. For example, even though a setting is made in the print job so that a reserved sheet feeding stage is “not used”, if a sheet feeding stage specified in the print job is a sheet feeding stage that is reserved, information indicating that the sheet feeding stage specified in the job is reserved may be displayed. At this time, the message 612 may also be displayed together. Even though a setting is made in the print job so that a reserved sheet feeding stage is “not used”, if a sheet feeding stage is not specified in the print job, but a sheet feeding stage identified based on the sheet size specified in the print job is only a sheet feeding stage that is reserved, another screen may be displayed. Specifically, the screen includes a message indicating that sheet feeding stages that store sheets of the specified sheet size are all reserved. Also at this time, the message 612 may be displayed together. Then, if a setting is made in the print job so that a reserved sheet feeding stage is “used”, and a sheet feeding stage specified in the print job is a sheet feeding stage that is reserved, but a sheet is not placed in the sheet feeding stage, the error screen 601 in FIG. 6 may be displayed.

An operation that can be performed by the user in a case where the error screen 601 in FIG. 6 is displayed is any of the following operations:
The out-of-sheets error is addressed by placing a sheet described in the message 612 (B4 and thick paper 1 in FIG. 6) in a sheet feeding stage described in the message 612 (a cassette 3 in FIG. 5).
The processing is forcibly continued with a sheet and a sheet feeding stage different from the sheet and the sheet feeding stage specified in the message 612 by selecting any of sheet feeding stage selection buttons 602 to 606.
The print job is stopped by selecting a “stop” button 610.

The CPU 201 waits for any of the above operations to be performed by the user. In step S412, if any change occurs in the states of the sheet feeding stages (YES in step S412), it is determined that there is a possibility that the user installed a sheet. Then, the processing returns to step S402, and the process of searching for an optimal sheet feeding stage is performed again. The change in the states of the sheet feeding stages refers to a change in the sheet size of a sheet placed in a particular sheet feeding stage or a change in the size or the type of a sheet set in a sheet feeding stage.

In step S413, if an instruction provided by the user is detected from the operation panel 105 (YES in step S413), the processing proceeds to step S414. In step S414, based on the content of the instruction, the CPU 201 switches the process to be performed next. If any of the buttons 602 to 606 is selected and an “OK” button 611 is selected (YES in step S414), then in step S410, a subsequent step in the flow is notified of the selected sheet feeding stage, and the sheet feeding determination process ends. If the pressing of the “stop” button 610 is detected (NO in step S414), then in step S415, the printing process ends.

If it is determined in step S409 that an optimal sheet feeding stage is not present, the execution of the print job may be cancelled. It is possible to prevent the execution of a job in which the use of a reserved sheet feeding stage is not specified and which uses a sheet feeding stage where a sheet feeding stage that is reserved is specified.

By executing the above processing, when a job in which the use of a reserved sheet feeding stage is not specified is executed, it is possible to prevent a sheet feeding stage that is reserved from being automatically selected. When a print job in which the use of a reserved sheet feeding stage is not specified is executed, and if a sheet feeding stage set in the job is a reserved sheet feeding stage, it is possible to display an error indication and prevent the reserved sheet feeding stage from being erroneously used. In other words, it is possible to prevent a sheet from being used for unintended printing. A sheet feeding stage is reserved independently of the execution of a print job, and therefore, even if the execution of the job is completed, the reservation is not automatically cancelled. Thus, it is possible to reserve the sheet feeding stage for a long period.

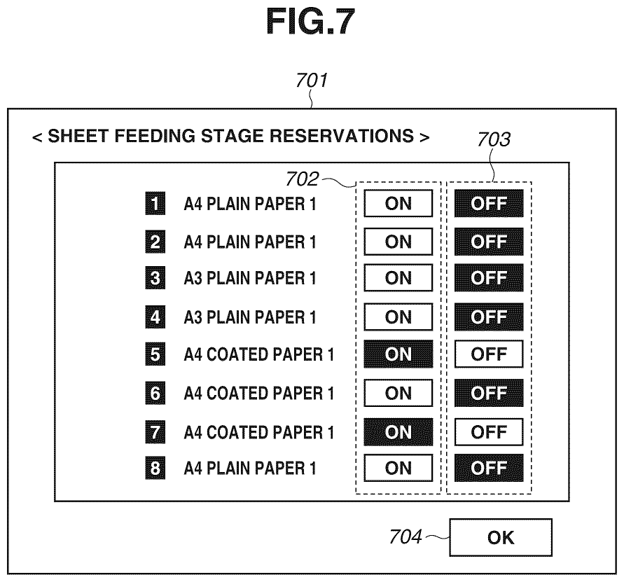

FIG. 7 illustrates a “sheet feeding stage reservations” screen 701 for displaying and changing the states of sheet feeding stage reservations that is displayed on the operation panel 105 of the image forming apparatus 103. The “sheet feeding stage reservations” screen 701 is displayed on the operation panel 105 by the CPU 201 via the operation panel interface 205 if an instruction to display the screen provided by the user is received from the operation panel 105. The “sheet feeding stage reservations” screen 701 includes the sizes and the types of sheets set in the sheet feeding stages 116-1 to 116-8, buttons 702 indicating that sheet feeding stage reservations are on, and buttons 703 indicating that the sheet feeding stage reservations are off. The buttons 702 and 703 double as buttons for setting the sheet feeding stage reservations, and the settings can be switched by selecting “on” and “off”. If an “OK” button 704 is selected, the CPU 201 updates the reservation state 506 based on the states of the buttons 702 and 703.

FIG. 8 is a diagram illustrating an example of a top screen 800 of a sheet management application executed by the print control apparatus 102 according to the first exemplary embodiment.

The top screen 800 illustrates an example of a screen in the state where information regarding the sheet feeding stages in the image forming apparatus 103 connected to the print control apparatus 102 is displayed. Based on an instruction from the CPU 301, image data of the top screen 800 is drawn in the video memory, and the image data drawn in the video memory is also output as a video signal to the display device 113, whereby the top screen 800 is displayed.

If the sheet management application starts, the sheet management application acquires device configuration information regarding the image forming apparatus 103 and displays a proper image based on this option information. FIG. 8 illustrates the state where eight sheet feeding stages are connected. Sheet feeding stage buttons 810 to 817 correspond to the respective sheet feeding stages.

Sheet feeding stage reservation buttons 820 to 827 are buttons for providing instructions to reserve the sheet feeding stages. An icon illustrated in the sheet feeding stage reservation button 824 indicates that the sheet feeding stage is reserved. An icon illustrated in the sheet feeding stage reservation button 827 indicates that the sheet feeding stage is not reserved. In the reservation of a sheet feeding stage, the CPU 301 acquires, via the LAN controller 306 and the control cable 108, the sheet feeding stage information as the setting information regarding each sheet feeding stage illustrated in FIG. 5 that is held in the image forming apparatus 103, and displays the sheet feeding stage information based on the information regarding the reservation state 506. When the sheet management application starts, or if the CPU 301 receives a reservation state change notification from the image forming apparatus 103, the CPU 301 switches the display of the sheet feeding stage reservation buttons 820 to 827. The on and off states of the reservations can be switched by selecting the sheet feeding stage reservation buttons 820 to 827. If the CPU 301 detects that any of the sheet feeding stage reservation buttons 820 to 827 is selected by the user, the CPU 301 instructs the image forming apparatus 103 to change the state of the sheet feeding stage reservation via the LAN controller 306 and the control cable 108. The image forming apparatus 103 receives the instruction and changes the state of the reservation state 506. Based on the information regarding the sheet feeding stages in the image forming apparatus 103 acquired when the sheet management application starts, the sheet management application creates and displays the sheet feeding stage buttons 810 to 817. For example, the sheet feeding stage buttons 810 to 817 each include an area that displays information such as the name of a sheet and the remaining amount of sheets set for the sheet feeding stage. If the states of the sheet feeding stages are changed in the image forming apparatus 103 and the CPU 301 receives a sheet feeding stage state change event from the image forming apparatus 103, the CPU 301 acquires the sheet feeding stage information again. Then, based on the acquired sheet feeding stage information, the CPU 301 draws the display areas of the sheet feeding stage buttons 810 to 817 again.

A “list of sheets” button 801 is a button for providing an instruction to display a “list of sheets” screen 830. In the first exemplary embodiment, if the “list of sheets” button 801 is selected, the CPU 301 displays the “list of sheets” screen 830 on the foreground. A setting button 802 is a button for providing an instruction to display a screen for changing the system settings of the sheet management application. If the setting button 802 is selected, the CPU 301 displays the current system settings based on the system settings saved in the external storage device 309.

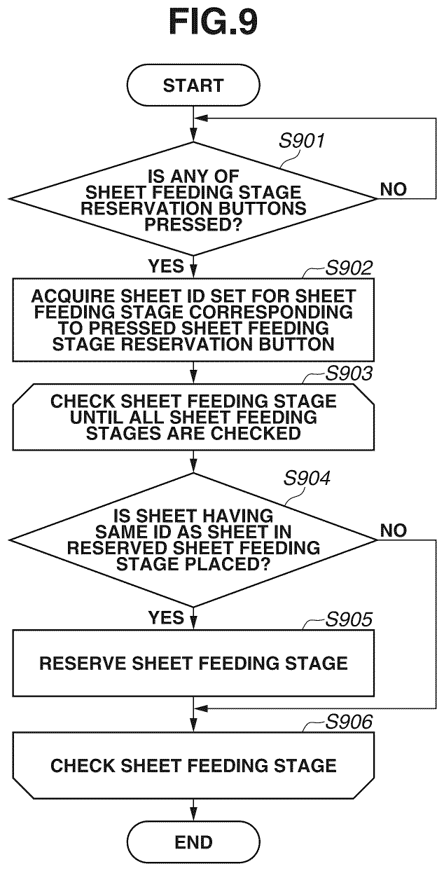

FIG. 9 is a flowchart when the sheet management application collectively reserves sheet feeding stages with sheets of the same type according to the first exemplary embodiment. This flowchart is executed by the CPU 301 by reading a program stored in the ROM 303.

In step S901, it is determined whether any of the sheet feeding stage reservation buttons 820 to 827 is selected.

If it is determined in step S901 that any of the sheet feeding stage reservation buttons 820 to 827 is selected (YES in step S901), then in step S902, a sheet ID set for the sheet feeding stage for which the reservation is set is acquired. More specifically, the sheet ID 504 in the sheet feeding stage information regarding the sheet feeding stage corresponding to the sheet feeding stage reservation button selected in step S901 is acquired from the sheet feeding stage information illustrated in FIG. 5. The sheet ID 504 is information stored in the ROM 203 of the image forming apparatus 103 and indicating the type of a sheet with a value determined in advance as in the sheet information list illustrated in FIG. 10. Steps S903 to S906 are a flow in which sheet feeding stages are reserved with sheets having the same ID as the sheet feeding stage reservation button selected in step S901.

In steps S903 to S906, determinations are made regarding all the sheet feeding stages included in the image forming apparatus 103. In step S904, it is determined whether a sheet having the same ID as the sheet ID acquired in step S902 is placed in a sheet feeding stage. More specifically, it is determined whether the sheet ID 504 has the same value. If it is determined in step S904 that the sheet ID 504 indicates the same sheet ID (YES in step S904), the processing proceeds to step S905. If it is determined in step S904 that the sheet ID 504 does not indicate the same sheet ID (NO in step S904), the processing proceeds to step S906. In step S905, the sheet feeding stage in which the sheet having the same sheet ID based on the determination is placed is automatically reserved without receiving a reservation instruction from the user. In the reservation of a sheet feeding stage, as described above, if the CPU 301 detects that any of the sheet feeding stage reservation buttons 820 to 827 is selected by the user, the CPU 301 changes the state of the sheet feeding stage reservation in the image forming apparatus 103 via the LAN controller 306 and the control cable 108. In step S906, if the determinations of all the sheet feeding stages are completed, the processing ends.

While the processing of this flow starts by the user providing an instruction to reserve a sheet feeding stage, the present disclosure is not limited to this. For example, information indicating the type of a sheet set for a sheet feeding stage is changed, whereby the changed information may become the same sheet information as that regarding a sheet feeding stage that is already reserved. In this case, to reduce the trouble of the user, the sheet feeding stage is automatically reserved. Specifically, the user changes the sheet information regarding the sheet feeding stage to the same sheet information as the sheet information set for the sheet feeding stage that is already reserved, whereby the CPU 201 automatically executes the process of reserving the sheet feeding stage regarding which the sheet information is changed. More specifically, the same information as information indicating the type of a sheet set for a sheet feeding stage restricted from being used for printing based on an instruction from the user is set for a sheet feeding stage that is not restricted from being used for printing, whereby printing using the sheet feeding stage is restricted without receiving the instruction from the user.

The above description has been provided using as an example the processing when a sheet feeding stage is reserved via the print control apparatus 102. In a case where a sheet feeding stage is reserved using the screen 701 of the image forming apparatus 103 as illustrated in FIG. 7, the CPU 201 executes processes similar to those of steps S901 to S906. In this case, the selection of a sheet feeding stage reservation button corresponds to the selection of a button 702 indicating the on state of a certain sheet feeding stage in FIG. 7.

While the flow in FIG. 9 ends after the process of reserving the sheet feeding stage is only automatically executed, the CPU 201 may display, on the operation panel 105, information indicating that the sheet feeding stage is automatically reserved (printing using the sheet feeding stage is restricted). More specifically, the same information as information indicating the type of a sheet set for a sheet feeding stage restricted from being used for printing based on an instruction from the user is set for a sheet feeding stage that is not restricted from being used for printing, whereby printing using the sheet feeding stage is restricted without receiving the instruction from the user. The CPU 201 may display, on the operation panel 105, information indicating that printing using the sheet feeding stage is restricted.

As described above, when a sheet feeding stage reservation button is selected, a sheet feeding stage that stores a sheet having the same sheet ID is also reserved, whereby it is possible to reserve sheet feeding stages with sheets of the same type by fewer operations. While in the present exemplary embodiment, the reservations of sheet feeding stages have been described, also regarding the cancellation of reservations, similarly, reservations are cancelled based on sheets having the same sheet ID, whereby it is possible to cancel the reservations of sheet feeding stages with sheets of the same type by fewer operations.

In the first exemplary embodiment, when a sheet feeding stage reservation button is selected, a reserved sheet feeding stage for which the same sheet ID is set is set. In the first exemplary embodiment, a sheet that ranges in the grammage 1004 is also included. For example, if a sheet having a grammage of 80 gsm is set for a sheet feeding stage 1 and a sheet having a grammage of 100 gsm is set for a sheet feeding stage 2, sheets placed in the sheet feeding stages 1 and 2 are different from each other, but the settings of the sheets are both plain paper 1. In this case, a case is also possible where one of the sheets is reserved, but the other sheet is not to be reserved. In view of this, a second exemplary embodiment directed to, in a case where a sheet is uniquely determined, collectively setting the reservations of sheet feeding stages will now be described.

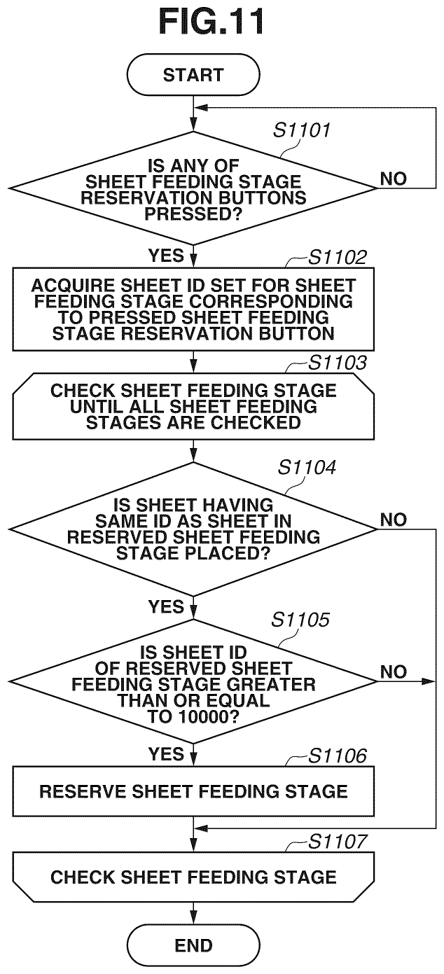

FIG. 11 is a flowchart when the sheet management application collectively reserves sheet feeding stages with sheets of the same type according to the second exemplary embodiment.

The flowchart is executed by the CPU 301 by reading a program stored in the ROM 303.

Steps S1101 to S1104 are similar to steps S901 to S904 in the first exemplary embodiment, and therefore are not described herein.

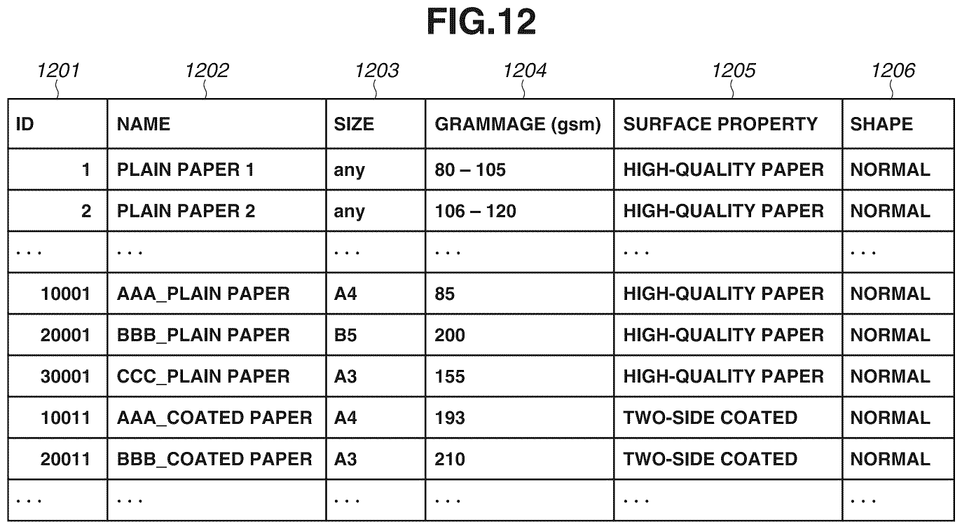

In step S1105, it is determined whether the sheet ID of the sheet feeding stage corresponding to the sheet feeding stage reservation button selected in step S1102 is greater than or equal to 10000. In a sheet information list in FIG. 12 stored in advance in the ROM 203 of the image forming apparatus 103, an ID 1201 greater than or equal to 10000 is set for a sheet of which a name 1202, a size 1203, a grammage 1204, a surface property 1205, and a shape 1206 are all uniquely determined. Then, based on the value of the ID 1201, it is possible to determine a uniquely determined sheet and a sheet that ranges in grammage. The determination of whether a sheet is a uniquely determined sheet is merely an example, and the determination may be made by comparing all the values of the items 1202 to 1206, or may be made using another method. For example, the sheet IDs may not be taken into account, and if the values of the grammage 1204 and the values of the surface property 1205 match each other, it may be determined that the same sheet information is set. In other words, the determination in step S904 in the first exemplary embodiment may be replaced with the determination using the values of the grammage 1204 and the surface property 1205. Alternatively, the determination may be made using only the grammage 1204, or the determination may be made using only the surface property 1205.

In step S1105, if the sheet ID is greater than or equal to 10000, i.e., the sheet is uniquely determined (YES in step S1105), the processing proceeds to step S1106. In step S1105, if the sheet ID is less than 10000, i.e., the sheet is not uniquely determined (NO in step S1105), the processing proceeds to step S1107. Steps S1106 and S1107 are similar to steps S905 and S906, and therefore are not described herein.

As described above, when a sheet feeding stage reservation button is selected, and only if a setting is made so that a corresponding sheet is uniquely determined, it is possible to collectively reserve sheet feeding stages with sheets of the same type.

In the first and second exemplary embodiments, descriptions have been provided of the methods for collectively reserving sheet feeding stages for which sheets of the same type are set. However, a case is also possible where sheet feeding stages are not to be reserved with sheets of the same type each time. For example, a sheet is placed in the sheet feeding stage 1 by the user, but a sheet of the same type is placed in another sheet feeding stage by another user, and a sheet feeding stage is reserved with only the sheet placed by the user. In view of this, a third exemplary embodiment directed to enabling the switching of a collective setting and an individual setting will now be described.

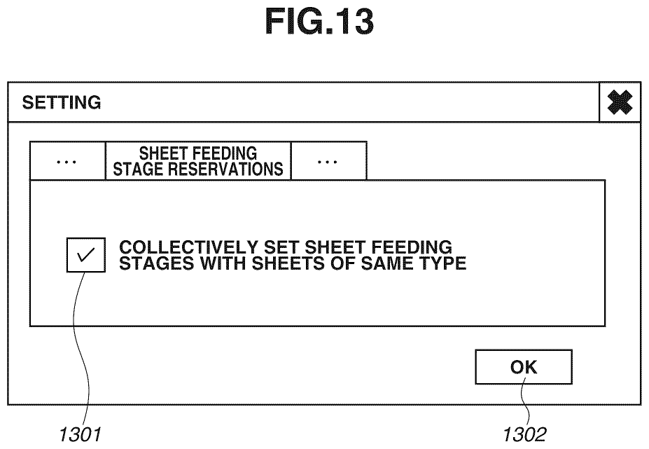

FIG. 13 is an example of a screen displayed when the CPU 301 that controls the sheet management application detects that the setting button 802 is selected according to the third exemplary embodiment. A collective setting change switch 1301 is a change switch for selecting whether to collectively reserve sheet feeding stages with sheets of the same type or individually set each sheet feeding stage. If an “OK” button 1302 is selected, the CPU 301 stores information regarding the collective setting change switch 1301 in the RAM 302. If a sheet feeding stage reservation button is selected when the collective setting change switch 1301 is stored in an “ON” state, the flowchart according to the first or second exemplary embodiment is executed. In other words, the reservations of sheet feeding stages are collectively set with sheets of the same type. When the collective setting change switch 1301 is stored in an “OFF” state, and if a sheet feeding stage button is selected, the reservation of the sheet feeding stage is only set. In the present exemplary embodiment, the print control apparatus 102 may not display the screen in FIG. 13, and the screen in FIG. 13 may be displayed on the operation panel 105 of the image forming apparatus 103.

As described above, a switch for selecting whether to collectively reserve sheet feeding stages with sheets of the same type is provided, whereby it is possible to use sheet feeding stages by switching selections according to the situation, such as collectively reserving sheet feeding stages with sheets of the same type or individually setting each sheet feeding stage.

In the third exemplary embodiment, an operation is performed after setting in advance whether to collectively reserve sheet feeding stages with sheets of the same type. This is user-unfriendly in a case where it is to be determined which of the settings is made each time. In view of this, a fourth exemplary embodiment directed to enabling the determination of whether to collectively set the reservations of sheet feeding stages with sheets of the same type when a sheet feeding stage reservation button is selected will now be described.

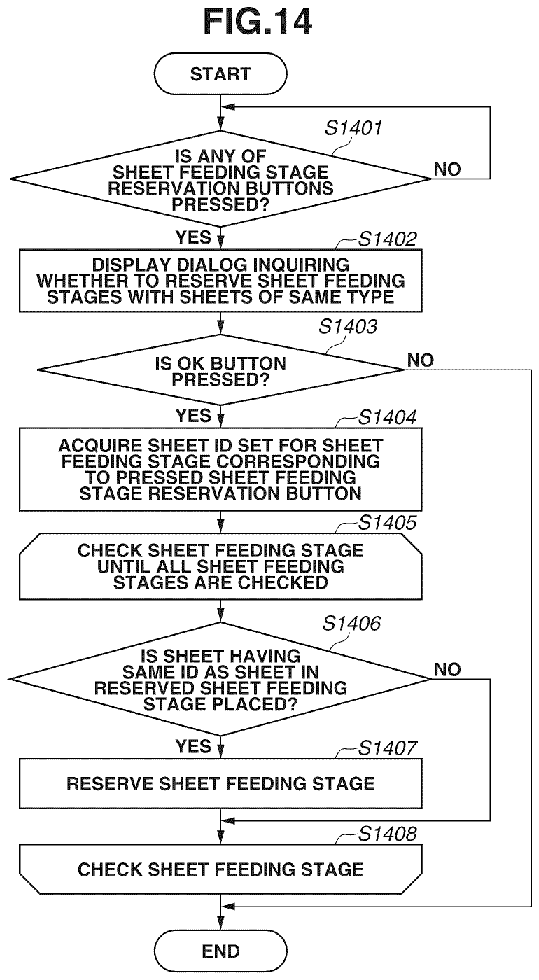

FIG. 14 is a flowchart when the sheet management application collectively reserves sheet feeding stages with sheets of the same type according to the fourth exemplary embodiment.

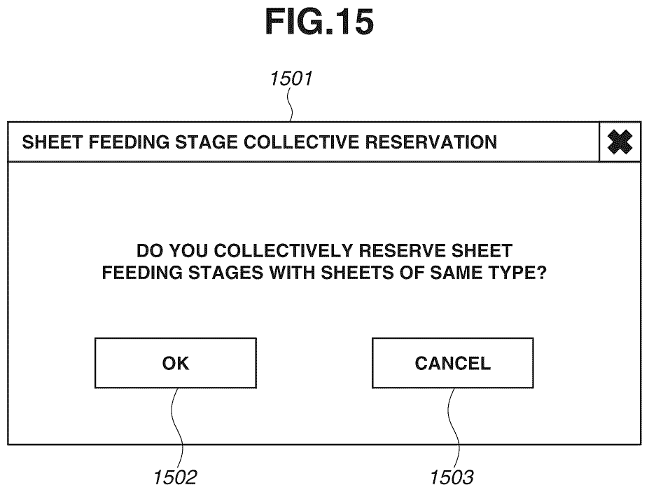

This flowchart is executed by the CPU 301 reading a program stored in the ROM 303. Step S1401 is similar to step S901 in the first exemplary embodiment, and therefore is not described herein. In step S1402, a “sheet feeding stage collective reservation” dialog 1501 illustrated in FIG. 15 is displayed. In step S1403, it is determined whether an “OK” button 1502 is selected or a “cancel” button 1503 is selected. If the “OK” button 1502 is selected (YES in step S1403), the processing proceeds to step S1404. If the “cancel” button 1503 is selected (NO in step S1403), the processing ends. Steps S1404 to S1408 are similar to steps S902 to S906, and therefore are not described herein.

While in the above description, an example has been described where the CPU 301 of the print control apparatus 102 executes the processing of the flow in FIG. 14, the CPU 201 of the image forming apparatus 103 may execute the processing of the flow in FIG. 14.

As described above, if a sheet feeding stage reservation button is selected, it is selected whether to reserve sheet feeding stages with sheets of the same type, whereby it is easy to select whether to reserve sheet feeding stage with sheets of the same type every time a sheet feeding stage is reserved. The present exemplary embodiment has been described based on the first exemplary embodiment, but can also be similarly achieved based on the second exemplary embodiment.

In the fourth exemplary embodiment, when a sheet feeding stage reservation button is selected, a dialog inquiring whether to collectively reserve sheet feeding stages with sheets of the same type is displayed. A case is also possible where not all, but some, of the sheet feeding stages are selected at this time. For example, this corresponds to a case where actually placed sheets are different from each other even with the same setting, such as a case where a sheet is not uniquely determined as in the plain paper 1.

In view of this, a fifth exemplary embodiment is directed to displaying a list of sheet feeding stages that store sheets of the same type when a sheet feeding stage is reserved, and reserving a selected sheet feeding stage.

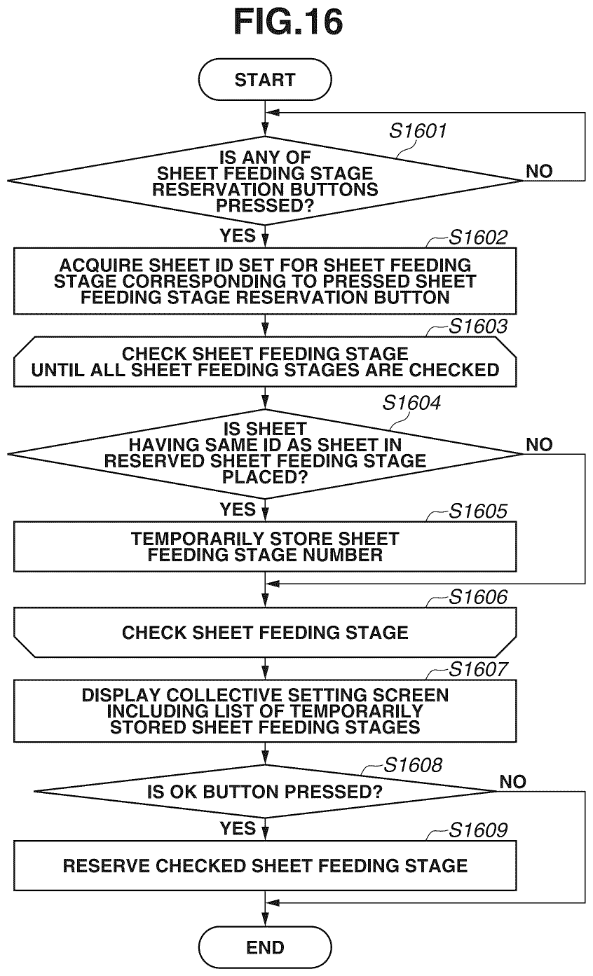

FIG. 16 is a flowchart when the sheet management application collectively reserves sheet feeding stages with sheets of the same type according to the fifth exemplary embodiment.

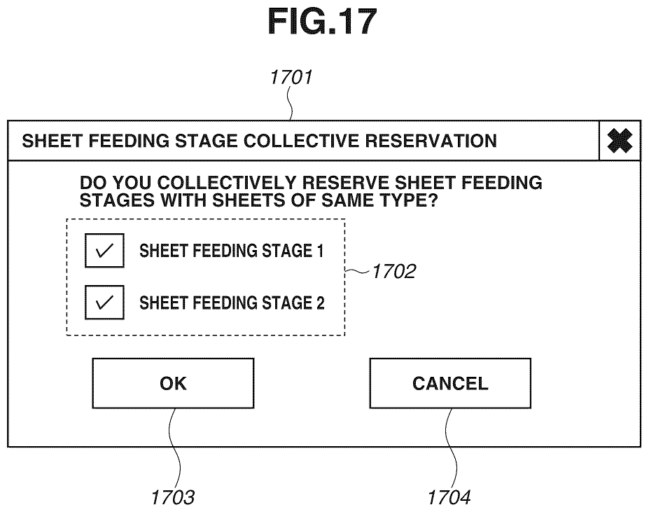

This flowchart is executed by the CPU 301 reading a program stored in the ROM 303. Steps S1601 and S1602 are similar to steps S901 and S902 in the first exemplary embodiment, and therefore are not described herein. In steps S903 to S906 in the first exemplary embodiment, if it is determined that the sheet is a sheet of the same type, the sheet feeding stage is reserved. In steps S1603 to S1606 in the fifth exemplary embodiment, however, the sheet feeding stage is not reserved, and the sheet feeding stage number of the sheet determined as a sheet of the same type is temporarily stored in the RAM 302. In step S1607, a “sheet feeding stage collective reservation” screen as illustrated in FIG. 17 including a list of sheet feeding stages stored in step S1605 is displayed. A selectable “sheet feeding stage collective reservation” dialog 1701 displays a list of sheet feeding stages 1702 for which sheets of the same type are set. An “OK” button 1703 and a “cancel” button 1704 are also placed. The settings of the list of sheet feeding stages 1702 may be all on or all off when the selectable “sheet feeding stage collective reservation” dialog 1701 is opened, or may be switched based on the reservation statuses of the sheet feeding stages at this time. In step S1608, it is determined whether the “OK” button 1703 is selected. If it is determined in step S1608 that the “OK” button 1703 is selected (YES in step S1608), the processing proceeds to step S1609. If the “cancel” button 1704 is selected in step S1608 (NO in step S1608), the processing ends. In step S1609, a sheet feeding stage checked from among the sheet feeding stages in the list of sheet feeding stages 1702 is reserved.

While in the above description, an example has been described where the CPU 301 of the print control apparatus 102 executes the processing of the flow in FIG. 16, the CPU 201 of the image forming apparatus 103 may execute the processing of the flow in FIG. 16.

As described above, when a sheet feeding stage is reserved, sheet feeding stages that store sheets of the same type are presented as candidates for a collective setting, whereby it is possible to collectively reserve any sheet feeding stages from among the sheet feeding stages that store sheets of the same type every time a sheet feeding stage is reserved.

While in the first to fifth exemplary embodiments, descriptions have been provided of the cases where a sheet feeding stage reservation button is selected, for example, a case is also possible where the sheet feeding stage 1 is already reserved, but a sheet of the same type is also set for another sheet feeding stage and used. More specifically, in a case where a sheet feeding stage is reserved with a sheet of the same type and used later, not when a sheet feeding stage reservation button is selected, the user needs to select the sheet feeding stage reservation button again in the first to fifth exemplary embodiments. In view of this, a sixth exemplary embodiment is directed to, in a case where a sheet of the same type as a sheet for a sheet feeding stage that is reserved is set for another sheet feeding stage, reducing operations of reserving the sheet feeding stage.

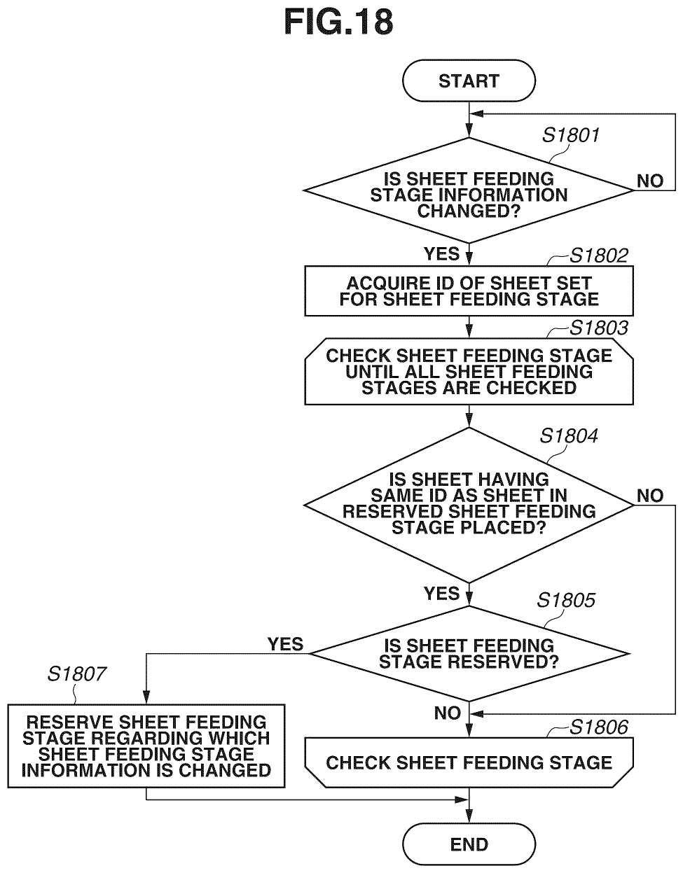

FIG. 18 is a flowchart when the sheet management application collectively reserves sheet feeding stages with sheets of the same type according to the sixth exemplary embodiment.

This flowchart is executed by the CPU 301 reading a program stored in the ROM 303. In step S1801, it is detected whether the sheet feeding stage information regarding any of the sheet feeding stages 116-1 to 116-8 is changed. If it is determined in step S1801 that the sheet feeding stage information is changed (YES in step S1801), the processing proceeds to step S1802. In step S1802, the ID of a sheet set for the sheet feeding stage regarding which the sheet feeding stage information is changed in step S1801 is acquired. In other words, the ID in the changed sheet ID 504 is acquired. In steps S1803 to S1806, regarding all the sheet feeding stages, it is determined whether a sheet feeding stage is reserved with a sheet of the same type as the sheet for the sheet feeding stage regarding which the sheet feeding stage information is changed in step S1801. In step S1804, it is determined whether a sheet having the same sheet ID as that of the sheet feeding stage regarding which the sheet feeding stage information is changed in step S1801 is set. If it is determined in step S1804 that a sheet of the same type is set (YES in step S1804), the processing proceeds to step S1805. If it is determined in step S1804 that a sheet of the same type is not set (NO in step S1804), the processing proceeds to step S1806. In step S1805, it is determined whether a sheet feeding stage for which the sheet of the same type is set according to the determination in step S1804 is reserved. If it is determined in step S1805 that the sheet feeding stage is reserved (YES in step S1805), the processing proceeds to step S1807. If it is determined in step S1805 that the sheet feeding stage is not reserved (NO in step S1805), the processing proceeds to step S1806. In step S1807, the sheet feeding stage regarding which the sheet feeding stage information is changed in step S1801 is reserved.

While in the above description, an example has been described where the CPU 301 of the print control apparatus 102 executes the processing of the flow in FIG. 18, the CPU 201 of the image forming apparatus 103 may execute the processing of the flow in FIG. 18.

As described above, when the sheet feeding stage information is changed, and if the sheet feeding stage is reserved with a sheet of the same type, the sheet feeding stage regarding which the sheet feeding stage information is changed is reserved, whereby it is possible to reduce the number of operations in a case where another sheet feeding stage is reserved with a sheet of the same type and used later.

As a variation of the sixth exemplary embodiment, as in the second exemplary embodiment, a sheet to be determined as a sheet of the same type may be limited to a uniquely determined sheet. As a variation of the sixth exemplary embodiment, as in the third exemplary embodiment, a screen that enables the setting of whether to reserve a sheet feeding stage when a sheet of the same type is placed may be provided in advance. As a variation of the sixth exemplary embodiment, as in the fourth exemplary embodiment, when a sheet is changed, and in a case where there is a sheet feeding stage that stores a sheet of the same type as a sheet for a sheet feeding stage that is reserved, a dialog inquiring whether to reserve the sheet feeding stage may be displayed. In the first to sixth exemplary embodiments, a sheet feeding stage that is used by temporarily placing a sheet as in a manual-bypass tray or a sheet feeding stage that is used by placing an insertion sheet as in an inserter may be excluded.

According to the present disclosure, it is possible to reduce the trouble of a user when printing using a particular sheet feeding stage is restricted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-027115, filed Feb. 27, 2024, which is hereby incorporated by reference herein in its entirety.

What is claimed is:

1. An image forming apparatus comprising:
a plurality of sheet feeding sections;
at least one memory storing instructions; and
at least one processor that, upon execution of the stored instructions, causes the at least one processor to:
print an image on a sheet, and
restrict, based on receiving an instruction from a user, printing using at least one of the plurality of sheet feeding sections,
wherein, in a case where same information as information indicating a type of a sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted.

2. The image forming apparatus according to claim 1, wherein the sheet feeding section restricted from being used for printing can be used for printing based on a print instruction from a particular user and cannot be used for printing based on a print instruction from a user different from the particular user.

3. The image forming apparatus according to claim 2, wherein a screen displayed in a case where the user different from the particular user is logged into the image forming apparatus and for selecting a sheet feeding section to be used for printing is displayed so that the sheet feeding section restricted from being used for printing cannot be selected.

4. The image forming apparatus according to claim 3, further comprising a display unit,
wherein the display unit displays the screen.

5. The image forming apparatus according to claim 1, wherein the sheet feeding section restricted from being used for printing can be used for printing based on a print job including information indicating that the sheet feeding section restricted from being used is to be used, and cannot be used for printing based on a print job that does not include the information indicating that the sheet feeding section restricted from being used is to be used.

6. The image forming apparatus according to claim 1, wherein the information indicating the type of the sheet is an identifier (ID) of the sheet.

7. The image forming apparatus according to claim 1, wherein the information indicating the type of the sheet is a grammage and a surface property of the sheet.

8. The image forming apparatus according to claim 1, wherein, in a case where the same information as the information indicating the type of the sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted, and information indicating that printing using the sheet feeding section is restricted is displayed.

9. A method of an image forming apparatus including a plurality of sheet feeding sections, the method comprising:
printing an image on a sheet; and
restricting, based on receiving an instruction from a user, printing using at least one of the plurality of sheet feeding sections,
wherein, in a case where same information as information indicating a type of a sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted.

10. The method according to claim 9, wherein the sheet feeding section restricted from being used for printing can be used for printing based on a print instruction from a particular user and cannot be used for printing based on a print instruction from a user different from the particular user.

11. The method according to claim 10, wherein a screen displayed in a case where the user different from the particular user is logged into the image forming apparatus and for selecting a sheet feeding section to be used for printing is displayed so that the sheet feeding section restricted from being used for printing cannot be selected.

12. The method according to claim 11, further comprising displaying the screen.

13. The method according to claim 9, wherein the sheet feeding section restricted from being used for printing can be used for printing based on a print job including information indicating that the sheet feeding section restricted from being used is to be used, and cannot be used for printing based on a print job that does not include the information indicating that the sheet feeding section restricted from being used is to be used.

14. The method according to claim 9, wherein the information indicating the type of the sheet is an ID of the sheet.

15. The method according to claim 9, wherein the information indicating the type of the sheet is a grammage and a surface property of the sheet.

16. The method according to claim 9, wherein, in a case where the same information as the information indicating the type of the sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted, and information indicating that printing using the sheet feeding section is restricted is displayed.

17. A non-transitory computer readable storage medium for storing a program causing an image forming apparatus including a plurality of sheet feeding sections to perform a method, the method comprising:
printing an image on a sheet; and
restricting, based on receiving an instruction from a user, printing using at least one of the plurality of sheet feeding sections,
wherein, in a case where same information as information indicating a type of a sheet set for the sheet feeding section restricted from being used for printing based on the instruction from the user is set for the sheet feeding section not restricted from being used for printing from among the plurality of sheet feeding sections, printing using the sheet feeding section without receiving the instruction from the user is restricted.
